(19) United States
(12) Patent Application Publication
(10) Pub. No.: US 2004/0111877 A1
(43) Pub. Date: Jun. 17, 2004

(54) Bendable armaflex with steady diameter

(76) Inventor: Jose Carlos Fajardo, Miami, FL (US)

Correspondence Address: Jose C. Fajardo, 7240 S.W. 12th Street, Miami, FL, 33144, US

(21) Appl. No.: 10/412,733

(22) Filed: Aug. 4, 2003

Related U.S. Application Data
(60) Provisional application No. 60/372,379, filed on Apr. 15, 2002.

(51) Int. Cl. B23P 21/00

(52) U.S. Cl. 29/782; 29/796; 29/820; 29/235; 29/281.1; 269/4; 269/9

(57) ABSTRACT

The Vendable Armaflex consists of a combination of Armaflex with spring in different diameters and allows to maintain the diameter and thickness necessary of the Armaflex according to the application.

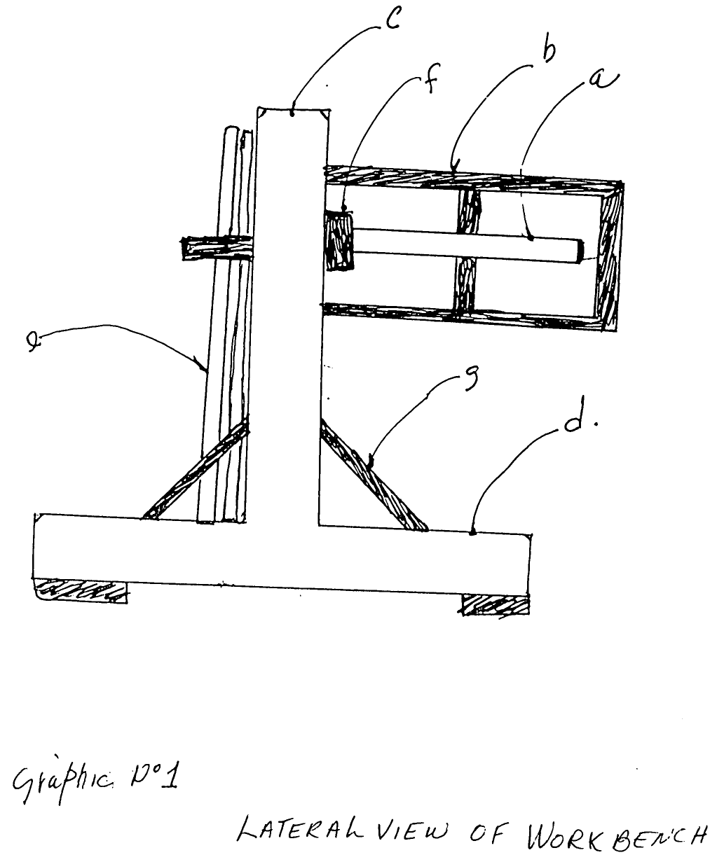

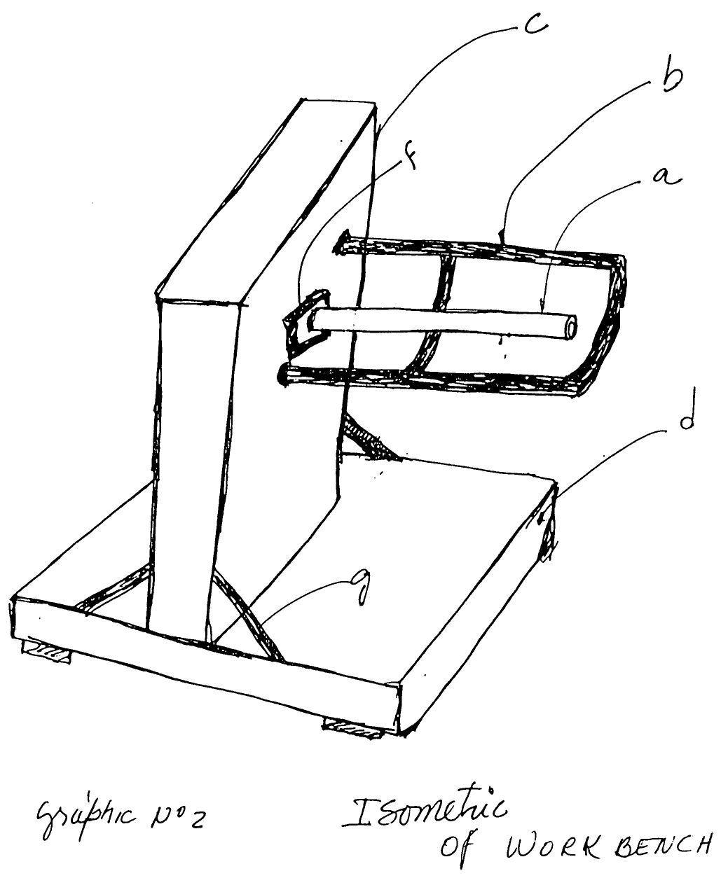

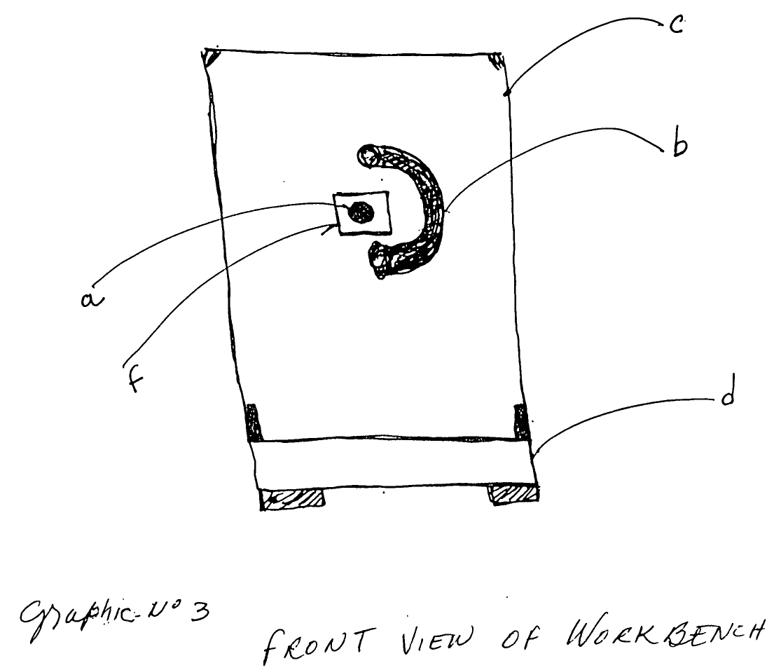

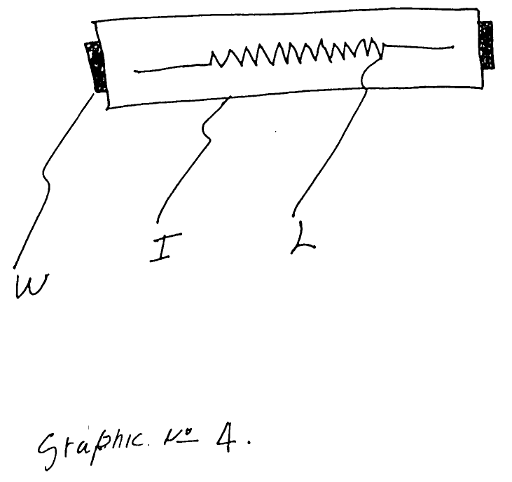

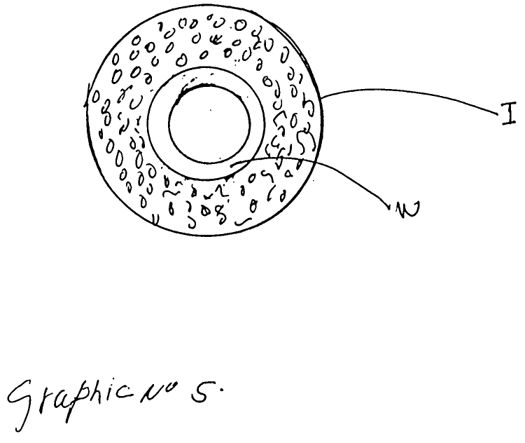

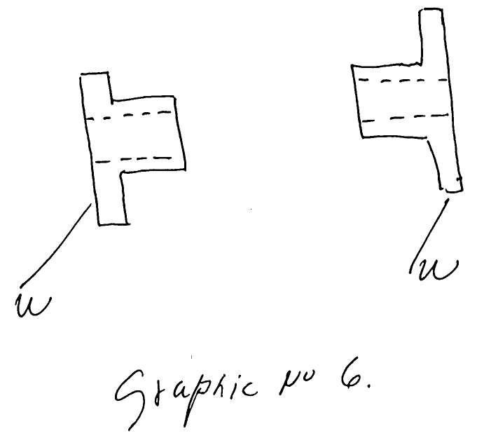

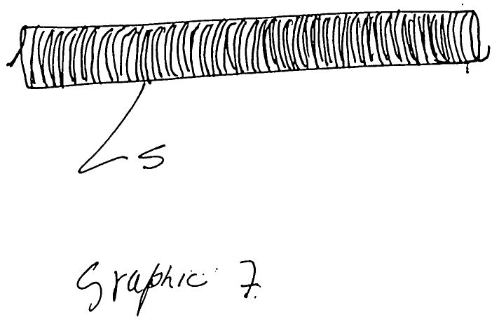

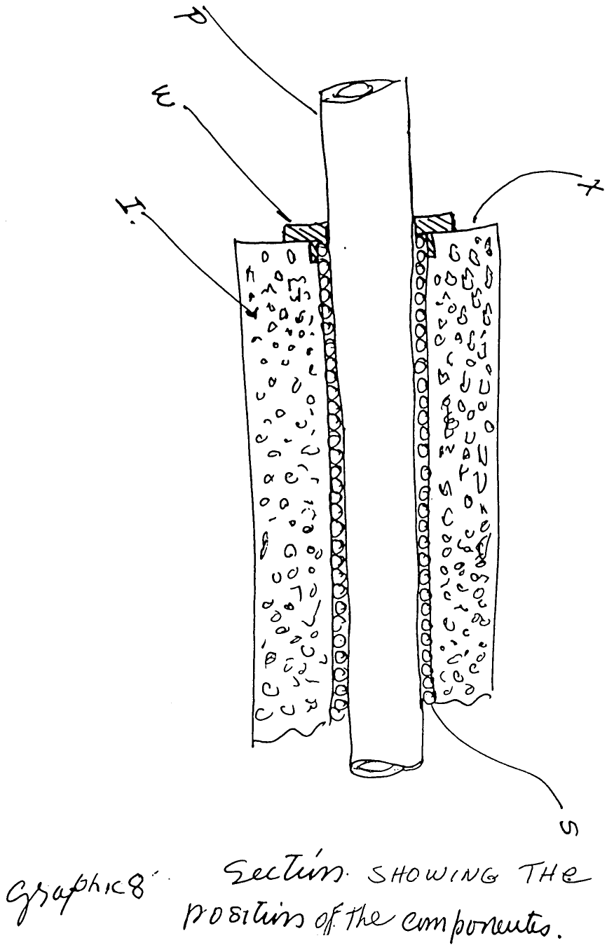

This combination will allow making projects with curvatures in the pipes, without having to cut the pipe. It will protect the diameter during the different applications, especially for refrigeration pipe type K from ½ inch to 1⅛ inches used in the suction or low pressure zone and that must be thermally insulated.

This application is based upon and claims the benefits of a provisional patent application Serial No. 60/372,379 filed on Apr. 15, 2002 with Confirmation #3825.

### BACKGROUND OF THE INVENTION

The use and application of insulated pipes Armaflex in Air Conditioning anid Refrigeration Systems is almost essential for two fundamental reasons:

1—To protect the walls, ceilings, and other areas of the humidity created by the condensation in the outer part of the suction pipes,

2—To diminish the overheating of the coolant.

During the installations of insulated pipes with Armaflex, it is necessary in many occasions to install many elbows and curvatures. Sometimes because of the rigidity of the pipes or because a rapid handling, the diameter of the pipes it is altered or obstructed, bringing as a result the malfunction of the Refrigeration System.

Based on these observations it is that I present this project.

### OBJECTIVES OF THE INVENTION

1—To manufacture or conform an Armaflex insulator combined with a spring.

2—To use this Armaflex as insulator and bender at the same time.

3—To be able to maintain the diameter in the pipes intact at elbows and curvatures.

4—To make the job of the installers of refrigeration and air conditioning pipes easier.

### SUMMARY OF THE INVENTION

This work consists of combining the Armaflex used to insulate refrigeration pipes with an integrated spring and obtain that the spring remains in place during the installation process. The sections of Armaflex, by norm, are manufactured in sections of 6′ long by different diameters and thickness in their walls.

This project does not try to replace the existing Armaflex. What we are trying to manufacture is a vendable Armaflex for special applications and that it will have great opportunities for numerous applications.

To combine the existent sections of Armaflex, we must create the necessary conditions to complete the task and also the materials to use.

For this project we need:

1—Armaflex. Sections manufactured within the norms of thickness and length.

2—Spring. Manufactured out of steel wire with diameter from 1/16 inches to ⅛ inches for the pipes that I propose from ½ inches to 1⅛ inches. These are the diameters of pipes that are most used in air conditioners and refrigeration installations. If the spring is for a pipe with a diameter larger than 1⅛″ then the diameter of the wire being used has to be larger. When the spring is used as vendable the turns in the wire have to be as close as possible.

3—Plastic washers. To assure that the spring does not come out from the Armaflex once installed.

4—Work area for a manual operation. I have designed the work area for a manual operation as follows:

a—Metal bar to introduce the spring within the Armaflex.

b—Safety protective bars to protect the operators. It can be mounted for left or right handed persons.

c—Column or vertical wall which is a base for the metal and protection bar.

d—Workbench or base.

e—Shelf for the bars and pipes of different diameters. See graphic corresponding to work bench.

f—Base to thread the metal bar.

g—Laminated sheets for reinforcements of the columns.

### DEVELOPMENT OF THE PROCESS

1—Select the bar to be used according to the diameter that is desired to work with.

2—Thread the bar in the base of the workbench.

3—Introduce the spring in the bar. Spring has been previously conformed.

4—Pass the Armaflex very carefully so it doesn't break or it gets damaged.

5—Install the plastic washier in the part that remains outside, still mounted to the bar.

6—Remove the Armaflex and spring from the bar.

7—Mount the other plastic washer at the other end.

8—Repeat and start again.

When we use the Armaflex combined with spring in the installations, since the pipes comes in 50 feet sections, we can manipulate and bend the pipe, to 90 degrees, or less than 90 degrees, according to the project, without having to cut the pipe, or without the diameter of the pipe being altered or become deformed.

This allows more precision, rapidity and quality. The measurements for the workbench are optional, but it must be proportional to the average height of the operators and if they are going to work seated or standing.

### GRAPHIC'S DESCRIPTION

Graphic #1

a—6 feet metal bar mold to mount spring according, to the diameter with female threads at one end.

b—Protection bars for the operators.

c—Base, column of the bar (a) and (b).

d—Base of the workbench. Size is optional.

e—Shelves containing bars of different sizes.

f—Base to screw the metal bar (a)

g—Reinforcement sheets for the vertical column.

Graphic #2: Isometric view of the workbench.

Graphic #3: Frontal view of the workbench,

Graphic #4: It shows the Armaflex, combined with the spring, plastic washers and the logo indicating that it is an Armaflex with spring.

w—Plastic washer.

i—Insulation Armaflex.

l—Logotype indicating that the Armaflex contains the spring.

Graphic #5: Frontal view of the Armaflex with the spring and the plastic washers. The exterior diameter of the Armaflex and the plastic washer could be seen.

Graphic #6: It shows the plastic washers used to attach the spring.

w—plastic washers.

Graphic #7: It shows the previously conformed spring to be the same length than the Armaflex.

s—Spring.

Graphic #8: A section of the Vendable Armaflex. It shows the position of the elements.

s—spring

I—insulation Armaflex

w—plastic washers

p—refrigeration pipes

x—exterior diameter of Armaflex and washer. Washer should be a minimum of ⅜ of an inch.

### ADVANTAGES

1—Allows a fast bending and at the same time maintains the diameter uniform.

2—Protects the diameter during blows.

3—Having an uniformed diameter, the possibility of the fluid loosing pressure is minimized.

4—Diminishes the numbers of weldable elbows.

5—An uniformed diameter allows greater return of oil to the compressor.

6—Diminishes the number of welds near combustible materials, walls and ceilings in buildings and houses.

7—Protects the pipes of external blows and pressures by the weight of soil or concrete.

8—It makes it easier for the pipe installer.

### CONCLUSION

With this new product we offered a suitable possibility of improving the quality of the pipes installations for Refrigeration and Air Conditioning.

It may also have an application in refrigeration systems on boats and refrigerated trucks like Thermo King.

If it is good for us today, it will be good for others later.

Thank you.

1. It is a claim that (a) in graphic (1) is a metal bar of different diameters to mount the spring inside the Armaflex, it should be 6 feet in length and threads in the column.

2. It is a claim that (b) in graphic (1) is a double protection bar for the operators, semi-circular on the front to allow the handling of the Armaflex that could be of 6′ or a bit longer.

3. It is a claim that \mathring{c} in graphic (1) is the wall or vertical column, which is the base for the metal bar (a) and the protection bars (b).

4. It is a claim that (d) in graphic (1) is a workbench.

5. It is a claim that (e) in graphic (1) are different bars in a shelf in the workbench.

6. It is a claim that (f) in graphic (1) is the threaded base of the bar (a).

7. It is a claim in graphic (4) the Armaflex combined with spring and washers. It could be manufactured by manual or other methods, It could be 6′ long with different diameters and thickness. (Logo indicates spring is inside)

8. It is a claim that (s) in figure (7) is the spring which is manufactured for the purpose of being used in pipes of 6′ long and 1/16″ to ⅛″ in diameter. It could be larger, according to the wire being used.
